(19) United States
(12) Patent Application Publication
(10) Pub. No.: US 2010/0158599 A1
(43) Pub. Date: Jun. 24, 2010

(54) WRITING INSTRUMENT WITH SHEET DISPENSER

(75) Inventor: DAVID C. WINDORSKI, WOODBURY, MN (US)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY

(21) Appl. No.: 12/643,048

(22) Filed: Dec. 21, 2009

Related U.S. Application Data
(60) Provisional application No. 61/140,668, filed on Dec. 24, 2008.

(51) Int. Cl. B43K 29/00

(52) U.S. Cl. 401/195

(57) ABSTRACT

A writing instrument comprising: (a) a body having opposing first and second ends, (b) a first marking element extending from the first end, (c) a second marking element extending from the second end, and (d) at least one sheet dispenser coupled to the body between the first and second ends.

### CROSS-REFERENCE AND PRIORITY CLAIM TO RELATED APPLICATION

This application claims priority to U.S. Provisional Patent Application No. 61/140,668, filed Dec. 24, 2008, the disclosure of which is incorporated by reference in its entirety.

### FIELD OF INVENTION

This invention relates to writing instruments, in particular, writing instruments that incorporate a sheet dispenser within the body and two marking elements.

### BACKGROUND

3M Company has introduced a wide variety of products and services to help consumers and office workers communicate, organize, and manage their information. For example, Post-it® Flags, have proven to be extremely useful for marking specific areas of documents, magazines, books, and the like. In general, the flag (also referred to as an “index”) is a polymeric or paper based material having a first and second end portions and first and second opposing major surfaces. The flag includes a repositionable adhesive one of a first or a second portion of its first or second major surface. In a polymeric flag, the first portion is typically transparent and is larger in size than the second portion, which is generally brightly colored. A plurality of flags is releaseably adhered to one another in a fan-fold (also referred to as “z-stacked”) configuration such that the repositionable adhesive in alternating flags is at alternating ends of the stack.

The flags have been integrated into writing instruments such as pens and highlighters. For example, 3M Company sells Post-it® highlighters and Post-it® pens. These integrated writing instruments provide a portable and convenient way to have flags readily available for a user wherever (s)he goes. Sheet material dispensers such as for flags integrated into pens and highlighters are described in, e.g., U.S. Pat. No. 6,719,472 (Windorski et al.), U.S. Pat. No. 7,144,870 (Windorski et al.), and U.S. Pat. No. 7,322,766 (Erlebacher et al.), and US Patent Publication No. 2005/0191114 (Smith et al.), and in Japanese Patent Application Publication Nos. JP2000025385 and JP11139081.

While the foregoing products are very useful, there is a desire to those skilled in the art for continued innovation of consumer related products.

### SUMMARY

The present invention pertains to a writing instrument having a sheet dispenser integrated into the body of the instrument and two marking elements.

In brief summary, a writing instrument of the invention comprises: (a) a body having opposing first and second ends, (b) a first marking element extending from the first end, (c) a second marking element extending from the second end, and (d) a sheet dispenser coupled to the body between the first and second ends. In some embodiments, the dispenser comprises (i) a base disposed on the body; and (ii) a cover removable from (e.g., slideably engageable with) the base, wherein the dispenser is disposed axially along a centerline of the writing element.

Advantageously, in one exemplary embodiment, the base of the sheet dispenser and the body are injection molded as an integral unit. In some embodiments, e.g., with a removable cover, the sheet dispenser is refillable with a new stack of sheets once a current stack has been consumed.

Writing instruments of the invention provide heretofore unattained convenience and utility. Provision of the sheet dispenser on the body of the writing instrument as provided herein means that sheets may be readily dispensed and used while one is holding the writing instrument, e.g., while using it. Sheets can be readily dispensed with the non-writing hand while the user holds the writing instrument in the hand with which they were writing. A difficulty with prior instruments in which the sheet dispenser was incorporated in the removable caps has been the inconvenience that the cap is removed while the instrument is in use and placed or left some distance away from the user, is obscured by working matter or other materials in close proximity to the area where the user is located, or is even lost.

### BRIEF DESCRIPTION OF THE DRAWING

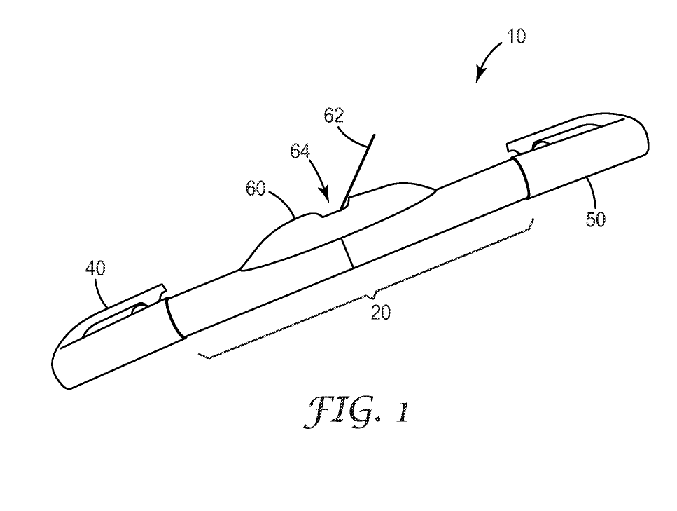

The present disclosure can be better explained with reference to the drawing, wherein FIG. 1 is a perspective view of an exemplary writing instrument of the invention.

The drawing presents the disclosure by way of illustrative representation and not limitation. Numerous modifications and embodiments can be devised by one skilled in the art which fall within the scope and spirit of the principals of this invention. The figure is idealized, are not drawn to scale, and are intended merely for illustrative purposes.

### DETAILED DESCRIPTION OF ILLUSTRATIVE EMBODIMENTS

The present disclosure provides a writing instrument integrated with a sheet dispenser. Because the dispenser has a compact footprint, it can be integrated into the body of the writing instrument which can be used for writing or working conventionally as well as carried in a pocket, placed in a drawer or pouch, etc. conveniently.

FIG. 1 depicts an illustrative embodiment of the invention wherein writing instrument 10 comprises (a) a body 20 having opposing first and second ends, (b) a first marking element (obscured under cap 40) extending from the first end, (c) a second marking element (obscured under cap 50) extending from the second end, and (d) a sheet dispenser 60 coupled to the body 20 between the first and second ends. In the embodiment shown, both cap 40 and cap 50 have a clip such as might be used to secure the instrument in a pocket. In the embodiment shown, a sheet 62 is shown protruding from dispenser 60, ready to pulled out or dispensed and used.

The body preferably provides a gripping surface where a user holds the writing instrument during use.

When not in use, each of the first marking element and the second marking element is typically protected by a removable cap.

The sheet dispenser is disposed on the body between the opposing first and second ends of the body. In some embodiments it will be located in the central portion of the body, i.e., substantially equidistant from the opposing first and second ends, and in some other embodiments it may be located closer to one opposing end than to the other if desired. The sheet dispenser typically includes a base and a slidably engaged cover to permit refilling. A stack of sheet is disposed in the dispenser 60 with an uppermost sheet 62 in the stack extending therefrom. The writing instrument has a centerline axis that runs along its length. In one exemplary embodiment, the sheet dispenser 60 is elongated and its longest axis lies parallel to the centerline axis of the writing instrument.

The first and second marking elements may be selected from many known marking means, e.g., crayon, pigment (e.g., pencil), ink-based elements (such as a pen), or fluid based elements (such as a highlighter. In one exemplary embodiment, the first and second marking elements both are ink based. In another exemplary embodiment, the first and second marking elements are both fluid based. In yet another element the first marking element is ink-based and the second marking element is fluid based, or vice-versa. In one exemplary embodiment, the first marking element is a dry erase marker and the second marking element is an ink-based pen, permitting use of the single writing instrument to mark a dry erase board and also to take hand-written notes. In another exemplary embodiment, the first marking element is a highlighter while the second marking element is an in-based pen permitting use of the single writing instrument, e.g., by a student, to highlight portions of a text, write down notes, and mark pages using sheets pulled from the dispenser as flags.

The dispenser 60 has a slot 64 that provides an opening for a top most sheet 62 in the stack of sheets to extend from the dispenser. The slot width is sufficiently wide to allow for the dispensing of the sheets.

The slot may consume only a portion of the available surface area of the top, or, in another exemplary embodiment, the slot consumes most of the top of the dispenser. In such an embodiment, the back wall and side walls of the cover, along with the back wall and sidewalls of the base provide sufficient structure to the dispenser such that a non z-stacked stack of sheets can be used in the dispenser. A bottom most sheet of the non z-stacked stack of sheets can be adhesively attached to the base.

In yet another embodiment, the writing instrument includes a sheet dispenser that has only the base and the cover is optional. In such an application, the stack of sheets can be adhered to the base.

In one illustrative embodiment, the length of the writing instrument, as measured from an end of the first cap to an end of the second cap is about 150 mm to about 160 mm. In some embodiments, the length of the sheet dispenser is from about 40 to about 50 mm. The dimensions, configuration, and shape of the dispenser, cover if any, slot will be dependent in part upon the sheets which will be used in the dispenser. For instance, the slot needs to be sufficiently large to permit removal of the sheets as desired without tearing, etc., the dispenser needs to be large enough to permit storage of an adequate number of sheets without undesirable curling, etc.

In general, the stack of sheets is a polymeric or paper based material having a first and second end portions and first and second opposing major surfaces. Each sheet includes a repositionable adhesive disposed on a first portion of its first major surface. In a polymeric sheet, the first portion is typically transparent and is larger in size than the second portion, which is generally brightly colored. A plurality of sheets is releaseably adhered to one another in a fan-fold (also referred to as “z-stacked”) configuration such that the repositionable adhesive in alternating sheets lies at alternating ends of the stack. Illustrative sheets and stacks of sheets that may be used in the present invention are disclosed in U.S. Pat. No. 4,907,825 (Miles et al.) and assignee's co-pending application U.S. patent application Ser. No. 11/843,235, filed Aug. 22, 2007. In one exemplary embodiment, the stack of sheets does not shuttle from one end of the dispenser to an opposing end of the dispenser. In this case, the longest dimension of the stack of sheets is just slightly smaller than (e.g., about 90% to about 95% of) the length of the dispenser. In another embodiment, the stack of sheets shuttle from one end wall to the opposing end wall. In this case, the length of the stack of sheets is noticeably smaller than the tension of the dispenser. The shuttling of a stack of sheets is disclosed in U.S. Pat. No. 4,907,825.

The sheets used in writing instruments of the invention may be paper note sheets, flags or indexes, etc., all of which are preferably adapted to be written on, preferably by at least one of the marking elements of the writing instrument. The sheets may be of desired color and may be preprinted with logos or emblems, e.g., for use in organizing or catergorizing information. Some illustrative examples include such legends as “YES”, “NO”, plus sign, minus sign, check mark, dollar sign, question mark, smiley face, frowning face, star, etc.

The writing instrument is typically polymeric and thus can be made by injection molding. In particular, the body (or a portion thereof) of the writing instrument, along with the base of the dispenser can be an integral unit, e.g., they can be injection molded as a one-piece unit.

Writing instruments of the invention may further comprise means for holding or storing the instruments with notebooks, dry eraseboards, etc., as desired. Illustrative examples include mating hook and loop fasteners, magnetic fasteners, mechanical fasteners such as snap-fit devices, lanyards, etc.

In some embodiments, the instrument may comprise more than one dispenser, e.g., positioned on opposing sides of the body disposed in substantially parallel orientation. Such embodiments can be filled with different sheets, e.g., index flags of different colors, to increase the utility of the invention.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A writing instrument comprising: (a) a body having opposing first and second ends, (b) a first marking element extending from said first end, (c) a second marking element extending from said second end, and (d) at least one sheet dispenser coupled to said body between said first and second ends.

2. The writing instrument of claim 1 wherein said sheet dispenser comprises (i) a base disposed on said body, and (ii) a cover removably engageable with the base, wherein the dispenser is disposed axially along a centerline of the writing element.

3. The writing instrument of claim 2 wherein the base of the dispenser is integrally formed with said body.

4. The writing instrument of claim 2 wherein said base of said dispenser comprises: (i) a substantially flat platform, a portion of which is disposed on said body, and (ii) a back wall and sidewalls extending laterally from the platform.

5. The writing instrument of claim 4 wherein the platform of the base has an exposed end that is distal to the back wall, and the platform having side channels along its edges.

6. The writing instrument of claim 1 further comprising a stack of sheets disposed in the dispenser.

7. The writing instrument of claim 6 wherein the sheet in the stack of sheets is polymer based or paper based, and wherein the sheets are in a z-fold or non z-fold configuration.

8. The writing instrument of claim 1 further comprising a first cap that is adapted to releasably engage with the first end of the body.

9. The writing instrument of claim 1 wherein the first cap has a closure portion and an end portion, the closure portion engagable with the first end or second end of the body.

10. The writing instrument of claim 8 wherein a lanyard is attached to the end portion of the first cap.

11. The writing instrument of claim 1 further comprising a second cap that is adapated to releasably engage with the first or second end of the body.

12. The writing instrument of claim 1 comprising a first marking element extending from the first end of the body and a second marking element extending from the second end of the body.

13. The writing instrument of claim 12 wherein the first writing element is ink marking or fluid marking and wherein the second writing element is ink marking or fluid marking.

14. The writing instrument of claim 1 wherein the cover of the dispenser has a top surface, a slot disposed at about a midpoint of the top surface, sidewalls, and a back wall extending laterally from the top surface.

15. The writing instrument of claim 14 wherein the slot in the cover of the dispenser is nearly the same dimension as that of a stack of sheets disposed in the dispenser.

16. The writing instrument of claim 14 wherein a bottom most sheet in the stack of sheets is adhesively attached to a platform of the base of the dispenser.

17. The writing instrument of claim 1 further comprising a cap that is adapted to releasably engage with at least one of said first end and said second end wherein said cap comprises a clip.
